(19) United States
(12) Patent Application Publication
(10) Pub. No.: US 2019/0202712 A1
(43) Pub. Date: Jul. 4, 2019

(54) BIOLOGICAL WASTE MANAGEMENT SYSTEMS

(71) Applicant: EnviroPure Systems, Inc, Travelers Rest, SC (US)

(72) Inventors: James Soniat, Simpsonville, SC (US); Thomas England, Travelers Rest, SC (US)

(21) Appl. No.: 15/862,293

(22) Filed: Jan. 4, 2018

(51) Int. Cl. C02F 1/00; C02F 1/66; C02F 3/02; C02F 3/34; B01D 21/24

(52) U.S. Cl. CPC C02F 1/004; C02F 1/006; C02F 1/66; C02F 3/02; C02F 3/34; C02F 2203/006; C02F 2209/005; C02F 2209/02; C02F 2209/03; C02F 2209/06; C02F 2301/08; B01D 21/24

(57) ABSTRACT

A waste management system is provided herein. The waste management system may include an accumulator tank, one or more digester tanks, and an air supply. The accumulator tank may define an accumulation chamber to receive a biologic waste or a decomposition agent. The one or more digester tanks may be spaced apart from the accumulator tank. Each digester tank may define a discrete digestion chamber in fluid communication with the accumulation chamber to selectively receive a slurry mixture comprising the biologic waste and the decomposition agent. The air supply may be in fluid communication with the digester tanks to selectively provide an aerating gas flow through a portion of the slurry mixture within one or more of the digestion chambers.

### FIELD OF THE INVENTION

The present subject matter relates generally to waste systems and more particularly to waste management systems for digesting and decomposing biologic waste, such as food.

### BACKGROUND OF THE INVENTION

Biological or biologic waste, such as discarded food items, creates a number of potential issues. For instance, food decomposing in a dumpster or landfill often emits high levels of methane. Bacteria may accumulate on the decomposing material and be spread to surrounding areas, such as by rats or other wildlife. Although waste is often transported by various waste management services or vehicles for remote processing, such transporting is generally inefficient and generates further waste (e.g., carbon dioxide, methane, etc.).

As a result, it may be desirable for biologic waste to be managed onsite (e.g., where such biologic waste is produced), such as at a corresponding supermarket, restaurant, or industrial food service location. However, current onsite food waste management systems have various shortcomings. For instance, current systems fail to manage waste decomposition efficiently. Waste generally accumulates as large particulate and decomposes within a single vessel or tank. Large volumes of water may be required to sufficiently soften and dilute the waste. Moreover, although decomposition of biologic waste often takes place over several days, new material can be regularly added to a given system. This may significantly slow the decomposition. Furthermore, each addition of new material can require further additions of water. Due, at least in part, to these shortcomings, current systems do not sufficiently reduce levels of biological oxygen demand (i.e., BOD), suspended solids, fats, oils, and greases.

Therefore, there is a need for improved waste management systems that address one or more of the above issues. In particular, it may be advantageous to provide a waste management that quickly and efficiently controls decomposition of biologic waste.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a waste management system is provided. The waste management system may include an accumulator tank, a water supply, a digester tank, and an air supply. The accumulator tank may define an accumulation chamber to receive a biologic waste or a decomposition agent. The water supply may be in fluid communication with the accumulator tank to provide a water flow to the accumulation chamber. The digester tank may be spaced apart from the accumulator tank. The digester tank may define a digestion chamber in fluid communication with the accumulation chamber to receive a slurry mixture comprising the biologic waste and the decomposition agent. The air supply may be in fluid communication with the digester tank to selectively provide an aerating gas flow through the slurry mixture within the digestion chamber.

In another exemplary aspect of the present disclosure, a waste management system is provided. The waste management system may include an accumulator tank, a plurality of digester tanks, and an air supply. The accumulator tank may define an accumulation chamber to receive a biologic waste or a decomposition agent. The plurality of digester tanks may be spaced apart from the accumulator tank. Each digester tank may define a discrete digestion chamber in fluid communication with the accumulation chamber to selectively receive a slurry mixture comprising the biologic waste and the decomposition agent. The air supply may be in fluid communication with the digester tanks to selectively provide an aerating gas flow through a portion of the slurry mixture within one or more of the digestion chambers.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a view of a waste management system according to exemplary embodiments of the present disclosure.

FIG. 2 provides a side sectional view of an accumulator tank according to exemplary embodiments, such as within the exemplary waste management system of FIG. 1.

FIG. 3 provides a side sectional view of a digester tank according to exemplary embodiments, such as within the exemplary waste management system of FIG. 1.

FIG. 4 provides a flow chart illustrating a method for operating a waste management system according to exemplary embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In order to aid understanding of this disclosure, several terms are defined below. The defined terms are understood to have meanings commonly recognized by persons of ordinary skill in the arts relevant to the present disclosure. The terms “includes” and “including” are intended to be inclusive in a manner similar to the term “comprising.” Similarly, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows.

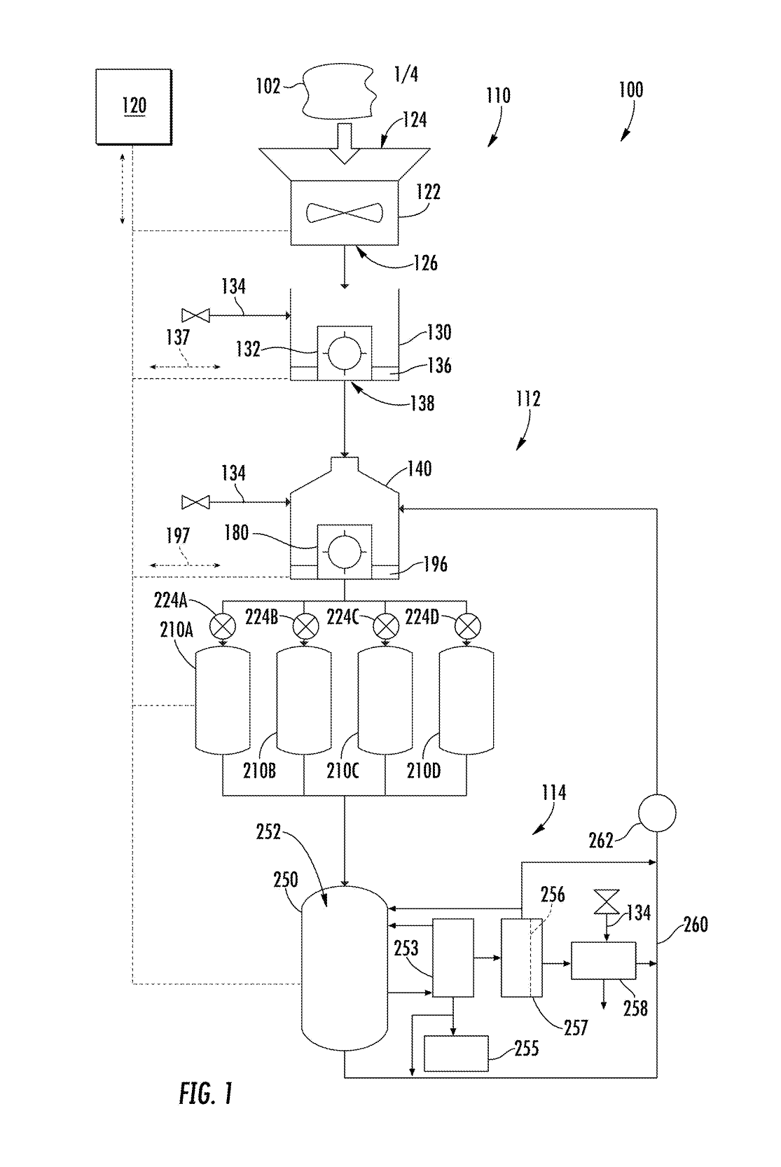

Turning now to the figures, FIG. 1 provides a view of an exemplary waste management system (WMS) 100 for digesting or decomposing biological waste material 102. Such waste material 102 may include various discarded food items, such as leftover, expired, spoiled, or otherwise unwanted or unsafe food products. Waste material 102 may be cooked or uncooked, and may be derived from plant or animal sources that include vegetables, fruits, meat, fish, poultry, dairy products, bones, shells, peels, pits, coffee grounds, fats, oils, and greases. As will be described in detail below, waste material 102 may be processed in various stages of WMS 100, which aid and facilitate decomposition of waste material 102 before it is transformed into one or more safe or usable materials that may be discharged from WMS 100 or reincorporated to another portion of WMS 100.

As illustrated, WMS 100 may include multiple discrete stages, such as an intake stage 110, a digestion stage 112, and an output stage 114, which will each be described in detail below. Several stages 110, 112, 114 of WMS 100 may be spaced apart from each other such that waste material 102 within such stages 110, 112, 114 is not commingled back and forth. In turn, waste material 102 may generally flow sequentially downstream from intake stage 110 to digestion stage 112, and from digestion stage 112 to output stage 114. In turn, one or more of the stages 110, 112, 114 may be connected (e.g., in fluid communication) through one or more suitable pipes or conduits. Moreover, it is understood that various additional flow components, such as valves, sensors, or pump assemblies, may be additionally provided along or between the various conduits for sensing or directing the flow of fluids through WMS 100 without departing from the present disclosure.

In some embodiments, a controller 120 is operably coupled (e.g., electrically coupled via one or more conductive wires, wirelessly coupled via one or more shared communications networks, etc.) to one or more of the stages 110, 112, 114 to control or direct operations thereof. As used herein, “controller” includes the singular and plural forms. Controller 120 may include one or more suitable devices, such as a general purpose processing device, a digital signal processor (DSP), an application specific integrated circuit (ASIC), a field programmable gate array (FPGA) or other programmable logic device, discrete gate or transistor logic, discrete hardware components, or any combination thereof designed and programmed to perform or cause the performance of the functions described herein.

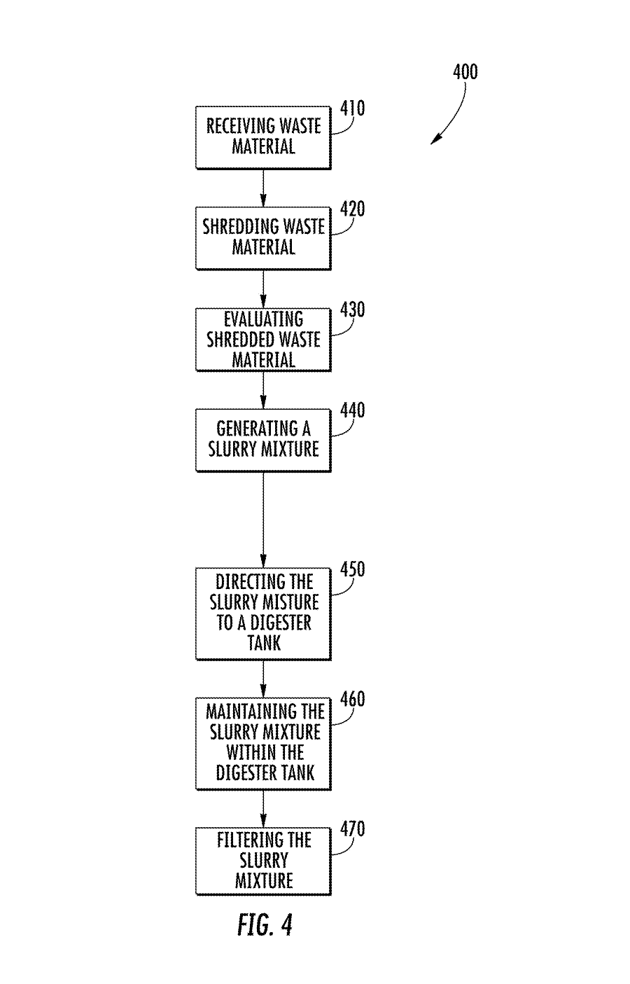

In some embodiments, a general purpose processing device includes one or more memory devices (e.g., nontransitive storage media) and one or more microprocessors, such as a general or special purpose microprocessor operable to execute programming instructions or micro-control code associated with the operation of WMS 100. The memory devices or memory may represent random access memory such as DRAM, or read only memory such as ROM or FLASH. The memory may be a separate component from the microprocessor or may be included onboard within the microprocessor. The memory can store information accessible to processing device, including instructions that can be executed by processing device. Optionally, the instructions can be software or any set of instructions that, when executed by the processing device, cause the processing device to perform operations. For certain embodiments, the instructions include a software package configured to operate WMS 100 and initiate one or more predetermined sequences. For example, the instructions may include a software package configured to execute the exemplary method 400, described below with reference to FIG. 4.

A user interface (not pictured), may be further provided and allow a user to activate various operational features or modes and monitor the operation of WMS 100. The user interface panel may include input components, such as one or more of a variety of electrical, mechanical or electro-mechanical input devices (e.g., rotary dials, push buttons, and touch pads), as well as a display component, such as a digital or analog display device designed to provide operational feedback to a user. Optionally, a communications module may be included to permit remote access or control through one or more wired or wireless connections.

In some embodiments, such as the embodiments illustrated in FIG. 1, intake stage 110 includes a waste shredder 122 to shred or slice input biological waste material 102. Waste shredder 122 may include a separate input 124 and output 126 for receiving substantially whole waste material and exhausting shredded waste material, respectively. Optionally, waste shredder 122 may include one or more blades or cutter stacks. In some such embodiments, blades or cutter stacks are rotatably mounted within waste shredder 122. As waste material 102 is passed through waste shredder 122 (e.g., via gravity), relatively large pieces of waste material 102 may thus contact blades or cutter stacks and thereby tear or rip into relatively small pieces (e.g., less than ¼ inch in width or diameter).

Shredded waste material 102 (i.e., shredded biologic waste) from waste shredder 122 may be received within an intermediate hopper 130 (e.g., disposed below waste shredder 122). Such material 102 may generally collect within intermediate hopper 130 before being conveyed (e.g., pumped) therefrom.

In some embodiments, a water supply 134 in fluid communication (e.g., direct or indirect fluid communication) with intermediate hopper 130 may provide a flow of water to mix with the shredded waste material 102. Water supply 134 may include any suitable water source, such as a municipal water supply 134, well, lake or other natural water body, etc. Additionally or alternatively, water supply 134 may include a gray water source associated with WMS 100.

In certain embodiments, a scale 136 is mounted to (e.g., on or within) intermediate hopper 130. Generally, scale 136 may be configured to detect the mass or weight of shredded waste material 102 in intermediate hopper 130. For instance, scale 136 may include one or more pressure transducers, springs, strain gauges, or other suitable components to deflect or deform in response to an increased load. In some embodiments, scale 136 is operably coupled to controller 120. In turn, controller 120 may receive one or more mass signal from scale 136 (e.g., as generally indicated at arrow 137). From such signals 137, controller 120 may then determine the mass or weight of material on scale 136, as is generally understood.

In optional embodiments, an intake grinder pump 132 (e.g., submersible grind pump) is mounted to intermediate hopper 130, such as at bottom portion of intermediate hopper 130. Intake grinder pump 132 may be generally disposed at or within an outlet 138 of intermediate hopper 130. An internal grinding mechanism of intake grinder pump 132 may thus further grind and macerate shredded waste material 102 as it passes from intermediate hopper 130 and through outlet 138.

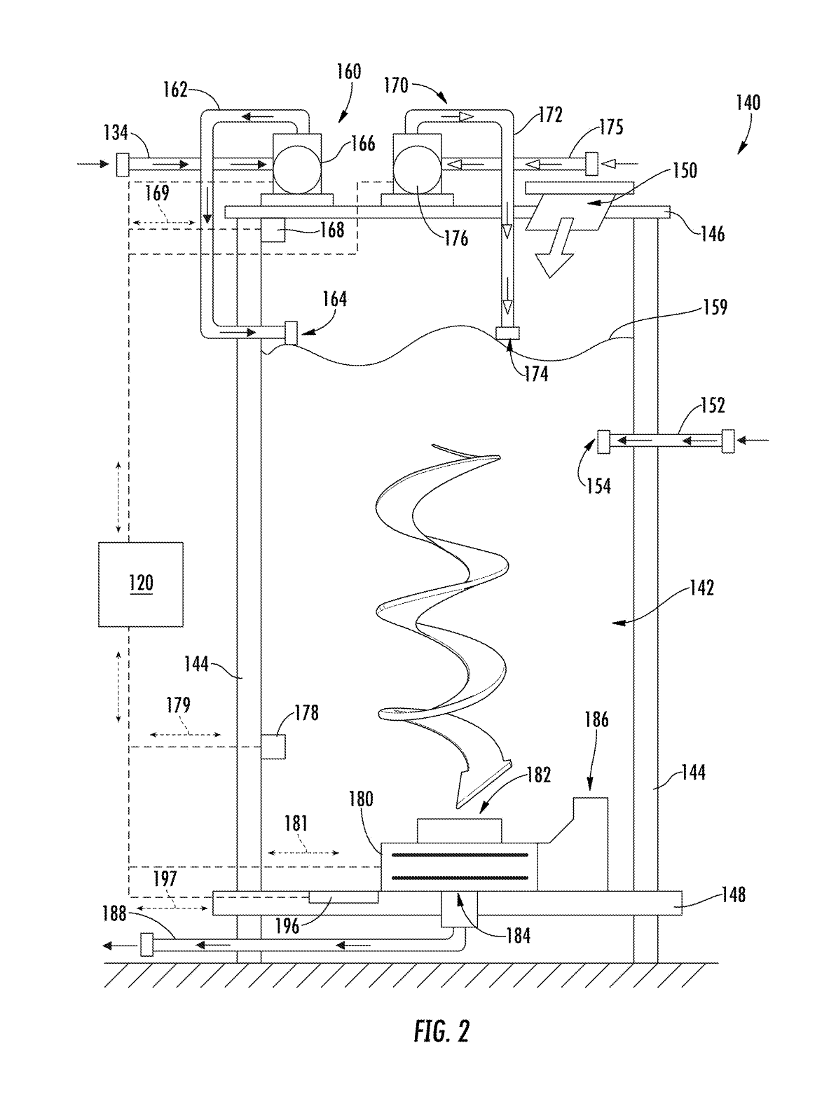

From intake stage 110, waste material 102 is generally conveyed or pumped to preparation state. For example, as illustrated, waste material 102 may travel to an accumulator tank 140 from intermediate hopper 130 (e.g., as motivated by a fluid pump). As will be described in detail below, accumulator tank 140 generally defines an accumulation chamber 142 (FIG. 2). Within accumulation chamber 142, accumulator tank 140 may receive and collect a decomposition agent, as well as biologic waste material 102, downstream from waste shredder 122 or intermediate hopper 130. A water supply 134 in fluid communication with the accumulator tank 140 may provide a flow of water to accumulator tank 140 to further mix with the decomposition agent and biologic waste material 102.

Referring now to FIGS. 1 and 2, FIG. 2 provides a sectional view of an exemplary embodiment of accumulator tank 140, which is illustrated in greater detail than may be shown in FIG. 1. As shown, accumulator tank 140 includes multiple sidewalls 144 extending between a top wall 146 and a bottom wall 148. Together, these walls 144, 146, 148 may enclose and define accumulation chamber 142 within accumulator tank 140. A waste opening 150 may be defined through at least one wall (e.g., top wall 146) such that waste material 102 may be received therein (e.g., from a conduit or duct extending in fluid communication between the intermediate hopper 130 and accumulator tank 140).

A charge conduit 152 extends from outside accumulator tank 140 to accumulation chamber 142 and defines a charge inlet 154 within accumulation chamber 142. Generally, charge conduit 152 may provide decomposition agent to accumulation chamber 142 through charge inlet 154. Within accumulation chamber 142, the decomposition agent may mix with waste material 102. Bacteria supplied within decomposition agent (e.g., hydrolytic, acetifying, or facultative bacteria) generally facilitate and accelerate decomposition of waste material 102. The decomposition agent may thus include any suitable bacteria culture and may be provided, for instance, from previously decomposed or digested material, as further described below.

A water supply system 160 is generally provided in fluid communication with accumulator tank 140. In some embodiments, a water conduit 162 defining a water inlet 164 is provided through at least one of walls (e.g., sidewall 144) in fluid communication with water supply 134. Optionally, a supplemental water pump 166 may be provided in fluid communication between water supply 134 and water inlet 164 to motivate water under sufficient pressure. Thus, water may be supplied to accumulation chamber 142 through water inlet 164 from water pump 166 and water supply 134. In some such embodiments, supplemental water pump 166 is operably coupled to controller 120. In turn, controller 120 may be configured to selectively direct the supply or volume of water to accumulation chamber 142. Additionally or alternatively, a water sensor 168, such as a mechanical, acoustical, optical, or electrical field sensor, may be operably coupled with controller 120 and provided within accumulation chamber 142 or along water conduit 162. Water sensor 168 may generally detect a volume or flow of water, which is transmitted as a receivable signal (e.g., as generally indicated at arrow 169) to controller 120 for a determination of the volume of water conveyed to accumulation chamber 142. Water, along with waste material 102 and digestive material may come together within accumulation chamber 142 to create a fluid slurry mixture 159.

In some embodiments, an additive supply system 170 is further included with accumulator tank 140. An additive conduit 172 defining an additive inlet 174 may be provided through at least one of walls (e.g., sidewall 144). As illustrated, accumulation chamber 142 is in fluid communication with an additive supply 175, which may generally include one or more balancing additives, such as sodium bicarbonate (e.g., as a granulated particulate or dissolved solution), for adjusting the pH level of fluid slurry mixture 159. Optionally, an additive pump 176 may be provided in fluid communication with additive supply 175 and additive inlet 174 to motivate the additive(s) into accumulation chamber 142 through additive inlet 174. In some such embodiments, additive pump 176 is operably coupled to controller 120. In turn, controller 120 may be configured to selectively direct the supply or volume of additive to accumulation chamber 142.

As an example, a volume of additive may be directed to accumulation chamber 142 at a predetermined ratio (e.g., relative to mass) of additive per pound-mass of waste material 102. For instance, a mass of a base additive material (e.g., sodium bicarbonate) may be added as a predetermined ratio or fraction of digestive waste material. In optional embodiments, between 1 to 10 pounds-mass of granulated sodium bicarbonate may be added per one hundred pounds-mass of digestive waste. In further embodiments, between 3 to 4 pounds-mass of granulated sodium bicarbonate may be added per one hundred pounds-mass of digestive waste.

As an additional or alternative example, additive may be directed to accumulation chamber 142 based on a predetermined pH target. In particular, a pH sensor 178 within accumulation chamber 142 may transmit a pH signal (e.g., as generally indicated at arrow 179) to controller 120. Based on the received pH signal 179, controller 120 may determine a mass or volume of additive necessary to meet the pH target (e.g., according to a preset formula, reference table, etc.), and direct the determined mass or volume of additive to accumulation chamber 142.

As illustrated, a grinder pump 180 may be provided on or within accumulator tank 140 (e.g., in fluid communication with accumulation chamber 142). In particular, grinder pump 180 may be disposed in fluid communication with the accumulation chamber 142 to further grind and mix the slurry mixture 159. In particular, an internal grinding mechanism of intake grinder pump 180 may further grind and macerate shredded waste material 102 as it passes from an inlet 182 and through one or more outlets 184, 186. In some embodiments, grinder pump 180 is secured to the bottom wall 148 of accumulator tank 140. Optionally, one outlet 184 may be in fluid communication with a discharge conduit 152 through which the slurry mixture 159 may be evacuated from accumulation chamber 142. Additionally or alternatively, grinder pump 180 may be oriented with an outlet 186 within accumulation chamber 142. As an example, outlet 186 may be directed upward relative to the bottom wall 148 of accumulator tank 140. Additionally or alternatively, outlet 186 may be positioned at another suitable location to circulate the contents of accumulation chamber 142 and ensure no unground particles remain therein. In turn, the slurry mixture 159 is further mixed as particulate waste material is ground into smaller pieces and ejected (e.g., in an upward or otherwise suitable direction to prevent unmacerated food particles from remaining within slurry mixture 159) under pressure through outlet 186 to circulate within accumulation chamber 142. Advantageously, the further grinding of shredded waste material 102 may aid with decomposition and reduction of BOD and suspended solid levels, as well as a reduction of fats, oils, and greases.

In some embodiments, grinder pump 180 is operably coupled to controller 120. Controller 120 may be further configured to activate grinder pump 180 to motivate and grind the slurry mixture 159 therethrough. For instance, controller 120 may selectively activate grinder pump 180 continuously or intermittently based on a determined volume of slurry mixture 159, mass of waste material 120, or time at which waste material 102 is received.

It is noted that although one or more grinder pumps 180 may be provided within accumulator tank 140, additional or alternative embodiments include one or more separate grinders mounted within accumulator tank 140 to further grind waste material 102 that falls to the bottom of accumulator tank 140. In still further additional or alternative embodiments, a separate circulation system (not pictured), such as a circulation pump, rotating paddle, etc., further circulates, stirs, or agitates the slurry mixture 159 within accumulator tank 140.

In certain embodiments, a scale 196 is mounted to (e.g., on or within) accumulator tank 140. Generally, scale 196 may be configured to detect the mass or weight of shredded waste material 102 in accumulator tank 140 (e.g., before or after the addition of water, additives, or digestion agents). For instance, scale 196 may include one or more pressure transducers, springs, strain gauges, other suitable components to deflect or deform in response to an increased load. In some embodiments, scale 196 is operably coupled to controller 120. In turn, controller 120 may receive one or more mass signal (e.g., as generally indicated at arrow 197) from scale 196. From such signals 197, controller 120 may then determine the mass (e.g., in pounds-mass) of material on scale 196, as is generally understood.

In some embodiments, the addition of water within accumulation chamber 142 is at least partially contingent on the waste material 102 therein. As an example, the volume of water provided for the slurry mixture 159 may be based on a current signal (e.g., as generally indicated at arrow 181) received from grinder pump 180. In some such embodiments, a voltage of the electrical current at grinder pump 180 generally increases relative to the viscosity of the slurry mixture 159, or the size of particulate therein. If the voltage or amperage rises above a predetermined threshold, controller 120 may direct a set volume of water or an increased water flow (e.g., from water supply 134 through water conduit 162) to accumulation chamber 142.

As an additional or alternative example, the volume of water provided for the slurry mixture 159 may be based on a determined mass or weight of the shredded waste material 102. In some embodiments, controller 120 is configured to direct the flow of water (e.g., from water supply 134 to accumulation chamber 142) based on the determined mass. In particular, the volume of water directed to accumulation chamber 142, either directly or through another upstream location (e.g., intermediate hopper 130) may be between 0.075 and 0.3 gallons per pound (i.e., pound-mass) of the mass of shredded biologic waste material 102. As described above, the mass of shredded biologic waste material 102 may be determined based on one or more mass signals 137 or 197 received from scale 136 or 196. Alternatively, the determined mass may be based on a user input of waste size (e.g., in pounds or relative size) supplied, for instance, at the user interface of controller 120.

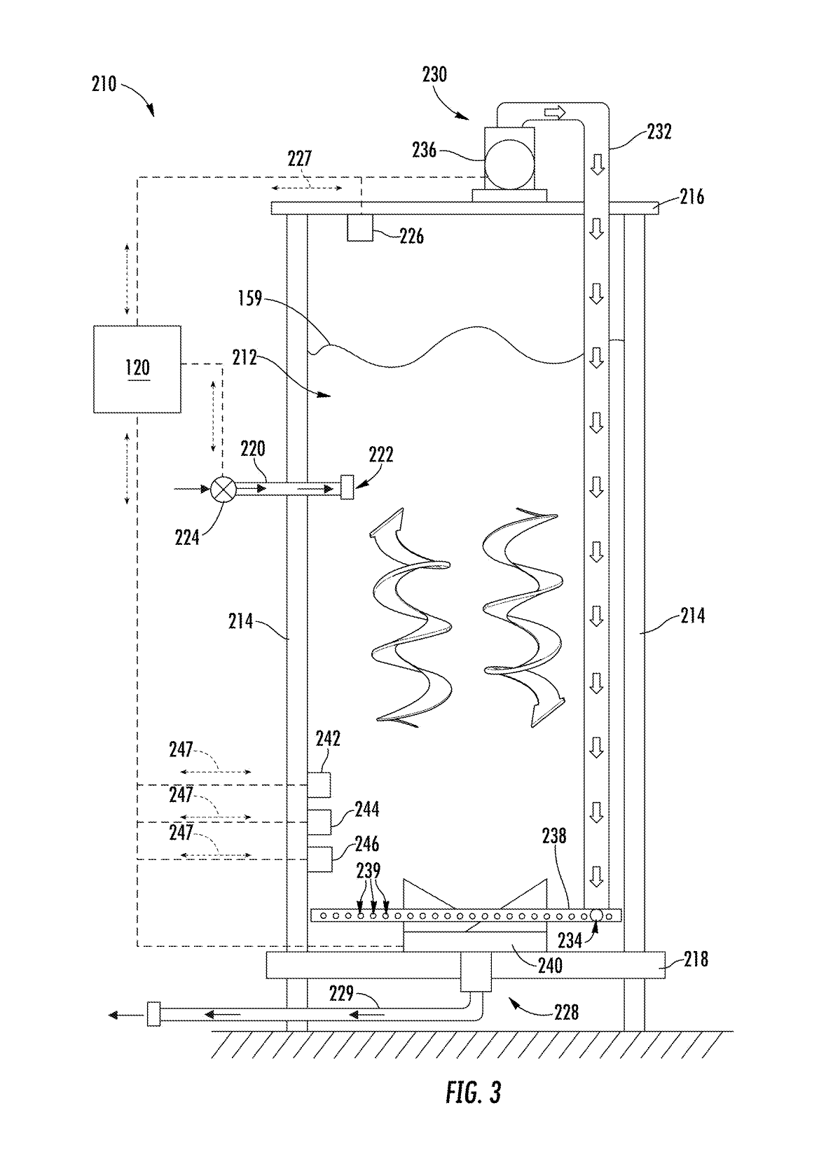

During operation of WMS 100, the slurry mixture 159 within accumulator tank 140 may be formed over a predetermined period of time. For instance, the slurry mixture 159 may grow with the addition of waste material 102 from user during the predetermined period of time (e.g., over the course of a 24 hour time period). Upon completion or expiration of the predetermined time period, the slurry mixture 159, including the waste material 102 or decomposition agent therein, is received within one or more digester tanks 210A, 210B, 210C, 210D of the digestion stage 112. In particular, at least a portion of slurry mixture 159 is received within a digestion chamber 212 (FIG. 3) defined by a corresponding one of digester tanks 210A, 210B, 210C, 210D.

Referring now to FIGS. 1 and 3, FIG. 3 provides a sectional view of an exemplary embodiment of a digester tank 210, which is illustrated in greater detail than may be shown in FIG. 1. It is understood that digester tank 210 may be provided as one of digester tanks 210A, 210B, 210C, 210D of WMS 100, as shown in FIG. 1. Optionally, each of digester tanks 210A, 210B, 210C, 210D of WMS 100 may be the same or substantially similar to digester tank 210. Additionally or alternatively, digester tanks 210A, 210B, 210C, 210D may each include another suitable structure that includes all or some of the features of digester tank 210. In some embodiments, each of digester tanks 210A, 210B, 210C, 210D is substantially similar in shape and size to the other digester tanks 210A, 210B, 210C, 210D. In alternative embodiments, however, one or more of digester tanks 210A, 210B, 210C, 210D have a unique shape or size to accommodate a different volume of slurry mixture 159 therein.

As shown, digester tank 210 includes multiple sidewalls 214 extending between a top wall 216 and a bottom wall 218. Together, these walls 214, 216, 218 may enclose and define digestion chamber 212 within digester tank 210. A fill conduit 220 extends from outside digester tank 210 to digestion chamber 212 (e.g., through one of walls 214, 216, 218) and defines a fill inlet 222 within digestion chamber 212. Generally, fill conduit 220 may provide at least a portion of slurry mixture 159 to digestion chamber 212 to decompose or digest therein.

Optionally, a chamber valve 224 may be provided in fluid communication between accumulator tank 140 and fill conduit 220 to selectively permit the passage of slurry mixture 159 into digestion chamber 212 through fill inlet 222. In some such embodiments, chamber valve 224 is operably coupled to controller 120. In turn, controller 120 may be configured to selectively direct the flow or volume of slurry mixture 159 to digestion chamber 212.

In certain embodiments, a fluid sensor 226, such as a mechanical, acoustical, optical, or electrical field sensor, is operably coupled with controller 120 and provided within digestion chamber 212 or along fill conduit 220. Fluid sensor 226 may generally detect a volume or flow of slurry mixture 159, which is transmitted as a receivable signal (e.g., as generally indicated at arrow 227) to controller 120 for a determination of the volume of slurry mixture 159 conveyed to digestion chamber 212. Additionally or alternatively, fluid sensor 226 may detect an unexpected decrease in volume of slurry mixture 159, which may indicate excessive evaporation within digestion chamber 212.

In some embodiments, an air supply system 230 is further included with digester tank 210. A gas conduit 232 defining gas inlet 234 may be provided through at least one of walls (e.g., top wall 216) in fluid communication with an air supply. For instance, gas conduit 232 may be fluidly connected to a compressor 236 that is operably coupled to controller 120 and positioned outside of digester tank 210. As shown, gas inlet 234 is connected to one or more diffusers 238 defining multiple outlets 239 within digestion chamber 212 (e.g., proximate to bottom wall 218). During use, air supply system 230 may thus provide a desired compressed gas, such as ambient air or oxygen, to the slurry mixture 159 within digestion chamber 212. As supplied through gas inlet 234 and the outlets 239 of diffuser 238, the desired compressed gas generates an aerating gas flow through the slurry mixture 159 within digestion chamber 212. Upon exiting outlets 159, the aerating gas flow may thus rise from a bottom portion of the digestion chamber 212 to a top portion of digestion chamber 212 further aiding in decomposition of waste material within slurry mixture 159. In optional embodiments, a slurry circulation system 240 is included within digestion chamber 212. Slurry circulation system 240 may include, for instance, a circulation pump, rotating paddle, etc., that further circulates, stirs, or agitates the slurry mixture 159 within digester tank 210 and promotes aeration of the slurry mixture 159.

Conditions within digestion chamber 212 may be detected by one or more slurry sensors operably coupled to controller 120. For instance, in some embodiments, a pH sensor 242 is mounted within digestion chamber 212 to detect pH levels of slurry mixture 159. In additional or alternative embodiments, an oxygen sensor 244 is mounted within digestion chamber 212 to detect oxygen (i.e., O₂) levels of slurry mixture 159. In still further additional or alternative embodiments, a temperature sensor 246 is mounted within digestion chamber 212 to detect the temperature at which slurry mixture 159 is being held.

During use, controller 120 may receive one or more signals (e.g., as generally indicated at arrows 247) from fluid sensor 226, pH sensor 242, oxygen sensor 244, or temperature sensor 246. Based on the received signal(s) 247, controller 120 may determine if the slurry mixture 159 is being maintained at a desired state (e.g., to facilitate growth and proliferation of bacteria responsible for the decomposition process). Moreover, based on the determined state (e.g., volume of slurry mixture, pH level, oxygen level, temperature, etc.) controller 120 may initiate one or more balancing actions, such as activation of air supply system 230 or slurry circulation system 240.

Once decomposition is complete, or evacuation of digester tank 210 is otherwise desired, controller 120 may direct digester tank 210 to evacuate the slurry mixture 159 from digestion chamber 212. For instance, controller 120 may transmit one or more evacuation signals to a separate exhaust system 228 having a discharge conduit 229 in fluid communication with one or more pumps or valves (not pictured) to control the flow of slurry mixture 159 from digestion chamber 212.

As illustrated, in FIG. 1, some embodiments include a plurality of digester tanks 210A, 210B, 210C, 210D that are spaced apart from accumulator tank 140 or each other. In some such embodiments, each of digester tanks 210A, 210B, 210C, 210D is mounted in fluid parallel to the other digester tanks 210A, 210B, 210C, 210D for selective fluid communication with accumulator tank 140. In other words, digester tanks 210A, 210B, 210C, 210D are in mutually-parallel fluid communication with accumulator tank 140. One or more chamber valves 224A, 224B, 224C, 224D may be provided between the digester tanks 210A, 210B, 210C, 210D and accumulator tank 140 to selectively restrict or permit the flow of slurry mixture 159 (FIG. 2) exhausted from accumulator tank 140 to a corresponding one of digester tanks 210A, 210B, 210C, 210D.

During use, the slurry mixture 159 within accumulator tank 140 may be directed in discrete batches to individual digester tanks 210A, 210B, 210C, 210D. In other words, a single batch of slurry mixture 159 from accumulator tank 140 is directed to a corresponding one of digester tanks 210A, 210B, 210C, 210D. The single batch may remain within the same one of digester tanks 210A, 210B, 210C, 210D until a decomposition process is substantially complete (e.g., when a predetermined decomposition time period has expired or the a desired level of BOD within the slurry mixture 159 has been reached). Subsequent batches are directed to separate digester tanks 210A, 210B, 210C, 210D and are not commingled during decomposition. Advantageously, individual batches may decompose at relatively fast rate and require relatively little water (e.g., when compared to non-batched decomposition having new material repeatedly introduced and commingled therein). Moreover, multiple batches may decompose simultaneously while ensuring any failure or contamination within one of digester tanks 210A, 210B, 210C, 210D does not affect the other digester tanks 210A, 210B, 210C, 210D.

It is noted that although four digester tanks 210A, 210B, 210C, 210D are illustrated in FIG. 1, different embodiments may include a larger or smaller number of discrete digester tanks 210A, 210B, 210C, 210D. For instance, some embodiments include between six and thirty digester tanks 210 (e.g., as few as six digester tanks 210 or as many as thirty digester tanks 210). In additional or alternative embodiments, the number of digester tanks 210 is determined according to the predicted decomposition time. As an example, the number of digester tanks 210 may be fourteen when the predetermined decomposition time is fourteen days. Thus, the digester tanks 210 may be continuously filled in overlapping batches. After one batch is decomposed and exhausted from a corresponding digester tank 210, a new batch of the slurry mixture 159 (FIGS. 2 and 3) may be supplied to that same digester tank 210 (e.g., through a corresponding chamber valve 224).

From the digestion stage 112, the slurry mixture 159 is exhausted to the output stage 114 as a decomposed mixture including digested material and gray water. As illustrated, the decomposed slurry mixture 159 (FIG. 3) flows to a post-digestion collecting tank 250 of the output stage 114 from one of digester tanks 210A, 210B, 210C, 210D. In particular, the decomposed slurry mixture flows to a collection chamber 252 defined by post-digestion collecting tank 250. Generally, collection chamber 252 may define a chamber volume that is greater than the chamber volume defined by the digestion chamber 212 (FIG. 3) of a single one of digester tanks 210A, 210B, 210C, 210D. In turn, at least one complete batch of digested material may be received within collection chamber 252. In certain embodiments, the chamber volume of collection chamber 252 is at least twice as large as the chamber volume defined by one digestion chamber 212. Advantageously, multiple tanks (e.g., at least two) of digester tanks 210A, 210B, 210C, 210D may exhaust their respective batches to collection chamber 252 at the same or overlapping times.

From post-digestion collecting tank 250, the received slurry mixture may be further processed. In some embodiments, at least a portion of the decomposed slurry mixture within collection chamber 252 is directed through one or more filtration platforms (e.g., a coarse filter tank 253 and/or fine filter tank 257).

Generally, coarse filter tank 253 may serve to separate digested material from at least a portion of the water in the decomposed mixture (e.g., a volume of gray water). For instance, coarse filter tank 253 may be provided as (or as part of) a filter press system. Thus, coarse filter tank 253 may utilize a pressure drive system, which serves to pressurize the contents of coarse filter tank 253 and separate substantially solid digested material from a volume of grey water. In optional embodiments, a large particulate filtration medium is included within coarse filter tank 253 to separate digested material from at least a portion of the water in the decomposed mixture (e.g., a volume of gray water). For instance, large particulate filtration medium may be included alone or as part of a filter press system. Moreover, large particulate filtration medium may include one or more filter screens. In some such embodiments, the filter screen is provided as a wire mesh. In other embodiments, the filter screen includes a plurality of holes arranged (e.g., in a diamond pattern) having staggered centers. The screens may be formed from stainless steel with a thickness of, for example, 0.0625 inches. The holes may be diameters of, for example, 0.0938 inches with a spacing of 0.3125 inches between the centers of holes in each row. The holes may further be staggered 0.15625 inches between the centers of adjacent holes in adjacent rows. Optionally, a pair of filter screens with offset holes may be provided to further restrict larger particulates from passing therethrough.

In certain embodiments, the fluid passed through coarse filter tank 253 may include digested material and gray water, at least a portion of which may be returned to collection chamber 252. Additionally or alternatively, at least a portion of digested material may bypass collection chamber 252 and flow to an upstream stage (e.g., to accumulator tank 140 through return line 260). Moreover, another portion of digested material (e.g., relatively large particulate material) may be exhausted from coarse filter tank 253 or collection chamber 252 (e.g., to a separate dewatering system 255 where the relatively large particulate material may be caked or otherwise transformed into a more compact form). Optionally, gray water or moisture extracted from the caked material may be returned to collection chamber 252.

In additional or alternative embodiments, a fine filter tank 257 is provided to further separate digested material from water in the decomposed mixture (e.g., a volume of gray water), for instance, after the digested material and water has been treated by the coarse filter tank 253. In some such embodiments, a small particulate filtration medium 256 is included within fine filter tank 257. Small particulate material may include one or more micron membranes defining multiple passages less than one micron in diameter. The resulting material passed through small particulate filtration medium 256 may be gray water suitable for further processing (e.g., within a water mixing tank 258 wherein gray water and fresh water are mixed with fresh water from water supply 134 before being exhausted from WMS 100 or returned to an upstream portion thereof). Optionally, at least a portion of the filtered digested material may be returned to the collection chamber 252. Additionally or alternatively, at least a portion of digested material may bypass collection chamber 252 and flow to an upstream stage (e.g., to accumulator tank 140 through return line 260).

In certain embodiments, digested material (e.g., received within collection chamber 252) can still include useable decomposition agents, such as bacteria for waste decomposition. In turn, a return line 260 may be provided in fluid communication between collection chamber 252 and accumulation chamber 142 (FIG. 2). The digested material may be flowed (e.g., as motivated by a separate return pump 262) from collection chamber 252 to accumulation chamber 142. In some such embodiments, the decomposition agent directed to the accumulation chamber 142 is provided from the digested material conveyed through return line 260. Thus, the decomposition agent may be the digested material guided by return line 260 to accumulation chamber 142 through charge conduit 152 (FIG. 2).

Turning now to FIG. 4, an exemplary method 400 of operating a waste management system 100 is illustrated. In exemplary embodiments, the various method steps as disclosed herein can be performed by controller 120 as part of an operating cycle that controller 120 is configured to initiate. During some such methods, controller 120 may receive inputs and transmit outputs from various other components of WMS 100. For example, controller 120 may send signals to and receive signals from waste shredder 122; sensors 168, 178, 226, 242, 244, 246; scales 136, 196; pumps 132, 166, 176, 180, 262; valves 224; or other relevant portions of stages 110, 112, 114.

Generally, FIG. 4 depicts steps performed in a particular order for purpose of illustration and discussion. However, those of ordinary skill in the art, using the disclosures provided herein, will understand that (except as otherwise indicated) the steps of any of the methods disclosed herein can be modified, adapted, rearranged, omitted, or expanded in various ways without deviating from the scope of the present disclosure.

As shown in FIG. 4, at 410, the method 400 includes receiving biologic waste material at an intake stage of the WMS. The biologic waste material may be provided, for instance, by a user loading or dumping the biologic waste material to the waste shredder.

At 420, the method 400 includes shredding waste material at the waste shredder. For instance, relatively large waste material may tear or rip, thus becoming relatively small pieces (e.g., less than ¼ inches in width or diameter) as the waste material passes through the waste shredder. After passing through the waste shredder, the biologic waste material (i.e., shredded waste material) may be collected in an intermediate hopper or accumulation chamber, as described above.

At 430, the method 400 includes evaluating the shredded waste material. In particular, the mass of the shredded waste material may be determined. In some such embodiments, a scale mounted to the intermediate hopper or accumulation chamber transmits a mass signal to the controller. Based on the received mass signal, the controller may determine the mass (e.g., in pounds-mass) of the shredded waste material.

At 440, the method 400 includes generating a slurry mixture that includes the shredded waste material. The slurry mixture may also include a volume of water, a decomposition agent, or an additive material (e.g., sodium bicarbonate). During 440, the slurry mixture (or components thereof) is further ground as it passes through one or more grinder pumps (e.g., within the intermediate hopper or the accumulation chamber).

In some embodiments, water is supplied to the shredded material (e.g., while the shredded material is in the intermediate hopper or the accumulation chamber). As an example, a volume of water may be supplied to the shredded material within the intermediate hopper or the accumulation chamber based on the mass determined at 430. As another example, a volume of water may be supplied to the shredded material within the accumulation chamber based on a detected current at the grinder pump within the accumulator tank.

In additional or alternative embodiments, a decomposition agent, such as previously-digested material, is supplied to the shredded material or water within the accumulation chamber, as described above. In still further additional or alternative embodiments, additive material is supplied to the shredded material, water, or decomposition agent within the accumulation chamber. For instance, the amount (e.g., mass) of additive material may be supplied at a predetermined ratio of additive per pound-mass of waste material, or according to a pH target, as described above.

Together, the constitute components may mix within the accumulation chamber as the slurry mixture is generated. Optionally, additional waste material (e.g., shredded waste material) or other components may be supplied to the slurry mixture within the accumulation chamber over a set period of time, such as a twenty-four hour time period, thus repeating 410 through 440.

At 450, the method 400 includes directing the slurry mixture to a digester tank. As described above, the digester tank may be one of a plurality of digester tanks. In turn, slurry mixture from the accumulator tank may be directed to multiple digester tanks in batches. For instance, a slurry mixture batch generated over a twenty-four hour time period may be directed to a first digester tank. Moreover, a new slurry mixture batch generated over a subsequent twenty-four hour period may be directed to a second digester tank.

At 460, the method 400 includes maintaining the slurry mixture within the corresponding digester tank. In particular, a single slurry mixture batch may be maintained or held within a single corresponding digester tank for a predicted or predetermined decomposition time. During that decomposition time, bacteria within the slurry mixture may decompose the biologic waste material. Moreover, the air supply system of the digester tank may aerate the slurry mixture, further aiding the decomposition.

At 470, the method 400 includes filtering the slurry mixture. In some embodiments, 470 begins upon completion of 460. As described above, a batch of the slurry mixture may be directed to a post-digestion collecting tank from which the digested material may be filtered and exhausted, for instance, as large particulate material, small particulate material, or gray water. Moreover, at least a portion of the digested material may be returned to the accumulation chamber as a decomposition agent.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A waste management system comprising:
an accumulator tank defining an accumulation chamber to receive a biologic waste or a decomposition agent;
a water supply in fluid communication with the accumulator tank to provide a water flow to the accumulation chamber;
a digester tank spaced apart from the accumulator tank, the digester tank defining a digestion chamber in fluid communication with the accumulation chamber to receive a slurry mixture comprising the biologic waste and the decomposition agent; and
an air supply in fluid communication with the digester tank to selectively provide an aerating gas flow through the slurry mixture within the digestion chamber.

2. The waste management system of claim 1, further comprising a plurality of digester tanks, each digester tank defining a discrete digestion chamber in mutually-parallel fluid communication with the accumulation chamber to selectively receive a portion of the slurry mixture, wherein the digester tank is one of the plurality of digester tanks.

3. The waste management system of claim 2, wherein the plurality of digester tanks comprises between six and thirty parallel digester tanks.

4. The waste management system of claim 2, further comprising a filter tank defining a filtration chamber in fluid communication with the plurality of digester tanks, wherein the filtration chamber defines a chamber volume at least twice as large as a chamber volume defined by one of the plurality of digester tanks.

5. The waste management system of claim 1, further comprising a filter tank defining a filtration chamber in fluid communication with the digester tank, the filter tank comprising a filtration medium enclosed within the filtration chamber.

6. The waste management system of claim 5, further comprising a return line extending in fluid communication between the filtration chamber and the accumulation chamber to guide at least a portion of the digested decomposition agent from the filtration chamber to the accumulation chamber.

7. The waste management system of claim 1, further comprising:
a grinder pump disposed in fluid communication between the accumulation chamber and the digestion chamber; and
a controller operably coupled to the grinder pump and the water supply to direct the water flow based on a current signal received from the grinder pump.

8. The waste management system of claim 1, further comprising:
a scale mounted to the accumulator tank to detect a mass therein; and
a controller operably coupled to the scale and the water supply to direct the water flow based on a mass signal received from the scale.

9. The waste management system of claim 1, further comprising a pH sensor mounted within the digestion chamber to detect a pH of the slurry mixture therein.

10. The waste management system of claim 1, further comprising a fluid sensor mounted to the digester tank to detect a volume of the slurry mixture therein.

11. A waste management system comprising:
an accumulator tank defining an accumulation chamber to receive a biologic waste or a decomposition agent;
a plurality of digester tanks spaced apart from the accumulator tank, each digester tank defining a discrete digestion chamber in fluid communication with the accumulation chamber to selectively receive a slurry mixture comprising the biologic waste and the decomposition agent; and
an air supply in fluid communication with the digester tanks to selectively provide an aerating gas flow through a portion of the slurry mixture within one or more of the digestion chambers.

12. The waste management system of claim 11, wherein the plurality of digester tanks comprises between six and thirty parallel digester tanks.

13. The waste management system of claim 11, further comprising a filter tank defining a filtration chamber in fluid communication with the plurality of digester tanks, wherein the filter tank comprises a filtration medium enclosed within the filtration chamber.

14. The waste management system of claim 13, wherein the filtration chamber defines a chamber volume at least twice as large as a chamber volume defined by one of the plurality of digester tanks.

15. The waste management system of claim 13, return line extending in fluid communication between the filtration chamber and the accumulation chamber to guide at least a portion of the decomposition agent from the filtration chamber to the accumulation chamber.

16. The waste management system of claim 11, further comprising:
a grinder pump disposed in fluid communication between the accumulation chamber and the digestion chamber.

17. The waste management system of claim 16, further comprising:
a water supply in fluid communication with the accumulator tank to provide a water flow to the accumulation chamber; and
a controller operably coupled to the grinder pump and the water supply to direct the water flow based on a current signal received from the grinder pump.

18. The waste management system of claim 11, further comprising:
a water supply in fluid communication with the accumulator tank to provide a water flow to the accumulation chamber;
a scale mounted to the accumulator tank to detect a mass therein; and
a controller operably coupled to the scale and the water supply to direct the water flow based on a mass signal received from the scale.

19. The waste management system of claim 11, further comprising a pH sensor mounted within the digestion chamber to detect a pH of the slurry mixture therein.

20. The waste management system of claim 11, further comprising a fluid sensor mounted to the digester tank to detect a volume of the slurry mixture therein.
